(19) United States
(12) Patent Application Publication
(10) Pub. No.: US 2023/0332668 A1
(43) Pub. Date: Oct. 19, 2023

(54) Vibration Isolation Apparatus with Thermally Conductive Pneumatic Chamber, and Method of Manufacture

(71) Applicant: NEWPORT CORPORATION, Irvine, CA (US)

(72) Inventor: Vyacheslav Ryaboy, Irvine, CA (US)

(73) Assignee: NEWPORT CORPORATION, Irvine, CA (US)

(21) Appl. No.: 17/721,834

(22) Filed: Apr. 15, 2022

(51) Int. Cl. F16F 15/023

(52) U.S. Cl. CPC F16F 15/0232; B33Y 80/00

(57) ABSTRACT

The present application discloses embodiments of a vibration isolation assembly configured to reduce the communication of excitation vibration between a supporting surface and a payload, at excitation frequencies significantly higher than the resonant frequency of the isolator. In one embodiment, the vibration isolation assembly includes a housing assembly having a housing body with a pneumatic chamber formed therein, wherein the housing assembly is supported by the supporting surface. The pneumatic chamber is configured to accept at least one fluid therein. A mass engaging member configured to support at least a portion of the payload is supported by the pneumatic chamber, and at least one thermally conductive member in thermal communication with the housing body is positioned within the pneumatic chamber. The thermally conductive member is configured to transfer thermal energy from the fluid in the pneumatic chamber to the housing body and into the ambient environment.

### BACKGROUND

Pneumatic vibration isolators are used for a variety of applications to create vibration-free environments for precise experiments and manufacturing operations in optoelectronics, life sciences, microelectronics, and nanotechnology. Besides effective vibration isolation characterized by natural frequencies as low as 1 Hz, pneumatic vibration isolators provide high load capacity that enables isolation of large equipment such as high-power lasers, atomic force microscopes, scanning tunneling microscopes, cryostats, and large optical assemblies. Some vibration isolators include damping elements (e.g., flow resistance orifices in the pneumatic chamber) configured to provide energy dissipation necessary to avoid excessive resonance vibration.

While these prior art pneumatic vibration isolators have proven useful in the past, a number of shortcomings have been identified. For example, prior art pneumatic vibration isolators that use flow resistance orifice damping elements do not provide highly effective vibration isolation at frequencies substantially higher than the resonance frequency of the isolator (e.g., 10-500 Hz). In light of the foregoing, there is an ongoing need for an improved pneumatic vibration isolator that provides highly effective isolation at high frequencies while providing acceptable performance at resonant frequencies.

### SUMMARY

The present application discloses embodiments of a vibration isolation assembly configured to reduce the communication of excitation vibration between a supporting surface and a payload, at excitation frequencies (e.g., ranging from 5 Hz to 500 Hz) significantly higher than the resonant frequency of the isolator. In one embodiment, the vibration isolation assembly has a resonant frequency of about 1 Hz. In another embodiment, the vibration isolation assembly has a resonant frequency between about 1 Hz and 5 Hz. In one embodiment, the excitation vibration is about five times that of a resonant frequency. In another embodiment, the excitation vibration is about ten times that of a resonant frequency.

In one embodiment, the vibration isolation assembly includes a housing assembly having a housing body with a pneumatic chamber formed therein, wherein the housing assembly is supported by the supporting surface. The pneumatic chamber is configured to accept at least one fluid therein. A mass engaging member configured to support at least a portion of the payload is supported by the pneumatic chamber, and at least one first thermally conductive member in thermal communication with the housing body is positioned within the pneumatic chamber. The first thermally conductive member is configured to transfer thermal energy from the fluid in the pneumatic chamber to the housing body and to the ambient environment. In some embodiments, the mass engaging member is configured to adjust the vertical position of the payload.

The first thermally conductive member may be formed from a material selected from a group consisting of aluminum, steel, stainless steel, copper, copper-tungsten, brass, bronze, polymers, diamond, composite materials, and ceramic materials. In one embodiment, the first thermally conductive member is a honeycomb structure. In another embodiment, the first thermally conductive member includes a thermally conductive body with a plurality of channels formed therein. The channels may have any of a variety of shapes, including, square, rectangular, triangular, pentagonal, hexagonal, octagonal, trapezoidal, circular, elliptical, or oval shapes. In an alternate embodiment, the first thermally conductive member is formed from a metal mesh. In another embodiment, the first thermally conductive member is formed from a plurality of metal tubes. In yet another embodiment, the first thermally conductive member is a heat sink. In still another embodiment, the first thermally conductive member is formed from a ceramic material. The pneumatic chamber may be placed in thermal communication with a thermally conductive fluid that is in contact with an outer surface of the housing body. In one embodiment, the payload supported by the vibration isolation assembly is an optical table top or a portion of an optical table top. In another embodiment, the vibration isolation assembly may include a second thermally conductive member secured to an outer surface of the housing body, wherein the second thermally conductive member may be formed from a variety of materials, including aluminum, steel, stainless steel, copper, copper-tungsten, brass, bronze, polymers, diamond, composite materials, and ceramic materials. Either of the first or second thermally conductive members may be formed monolithically with the housing body of the housing assembly. In another embodiment, the first thermally conductive member is a 3D-printed structure in thermal communication with the housing body, either formed separate from or monolithically with the housing body. The first thermally conductive member may be in thermal communication with the mass engaging member and/or the payload or a portion of the payload, and the mass engaging member may be configured to absorb thermal energy from the pneumatic chamber. The thermal energy absorbed by the first thermally conductive member and transferred to the housing body may be transferred away from the housing body by radiation, free convection, or forced convention. In an alternate embodiment, the vibration isolation assembly includes a thermal management system configured to remove thermal energy from the housing body. The thermal management system may include a heat exchanger such as an air-to-air heat exchanger, or a thermoelectric cooler. In another embodiment, the heat exchanger is placed in fluid communication with a secondary heat transfer device, such as a chiller.

### BRIEF DESCRIPTION OF THE DRAWINGS

Various embodiments of an improved vibration isolation assembly will be explained in more detail by way of the accompanying drawings, wherein:

FIG. 1 shows a schematic cross-section view of a single-chamber pneumatic vibration isolator;

FIG. 2 shows a mechanical model diagram of the single-chamber pneumatic vibration isolator shown in FIG. 1;

FIG. 3 shows a schematic cross-section view of a two-chamber pneumatic vibration isolator;

FIG. 4 shows a mechanical model diagram of the two-chamber pneumatic vibration isolator shown in FIG. 3;

FIG. 5 shows a graph of typical vibration transmissibility response for the pneumatic vibration isolators shown in FIGS. 1 and 3;

FIG. 6 shows a cross-section view of an alternate embodiment of a pneumatic vibration isolator;

FIG. 7 shows an experimental graph of vibration transmissibility response for the embodiment of a pneumatic vibration isolator shown in FIG. 6, compared to the two-chamber pneumatic vibration isolator shown in FIG. 3;

FIG. 8 shows a cross-section view of another embodiment of a pneumatic vibration isolator;

FIG. 9 shows a perspective view of the pneumatic housing and a thermally conductive member shown in FIG. 8.

FIG. 10 shows a detailed plan cross-section view of an embodiment of a thermally conductive member;

FIGS. 11-13 show plan cross-section views of various embodiments of a pneumatic vibration isolator housing having a thermally conductive member; and

FIG. 14 shows a perspective view of an embodiment of a pneumatic vibration isolator housing body and a thermally conductive member.

### DETAILED DESCRIPTION

Example embodiments are described herein with reference to the accompanying drawings. Unless otherwise expressly stated, in the drawings the sizes, positions, etc., of components, features, elements, etc., as well as any distances therebetween, are not necessarily to scale, and may be exaggerated for clarity. In the drawings, like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

The terminology used herein is for the purpose of describing particular exemplary embodiments only and is not intended to be limiting. Unless otherwise defined, all terms (including technical and scientific terms) used herein have the same meaning as commonly understood by one of ordinary skill in the art. As used herein, the singular forms “a,” “an” and “the” are intended to include the plural forms as well, unless the context clearly indicates otherwise. Also, the terms “at least one”, “at least a”, and “one or more” may are intended to include both the singular and plural forms, depending on the context. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless indicated otherwise, terms such as “first,” “second,” etc., are only used to distinguish one element from another. For example, one coupler could be termed a “first coupler” and similarly, another coupler could be termed a “second coupler”, or vice versa.

Unless indicated otherwise, spatially relative terms, such as “below,” “beneath,” “lower,” “above,” and “upper,” “opposing,” and the like, may be used herein for ease of description to describe one element or feature's relationship to another element or feature, as illustrated in the FIGS. It should be recognized that the spatially relative terms are intended to encompass different orientations in addition to the orientation depicted in the FIGS. For example, if an object in the FIGS. is turned over, elements described as “below” or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly. A set of reference axes (e.g., X, Y, Z), directions, or coordinates, and the rotation around them (e.g., θX, θY, θZ) may be included in the FIGS. for the purpose of orienting the reader to facilitate understanding of the FIGS. and the specification, and do not necessarily indicate that any particular feature or element is aligned with, or is orthogonal to, any other feature or element.

The paragraph numbers used herein are for organizational purposes only, and, unless explicitly stated otherwise, are not to be construed as limiting the subject matter described. It will be appreciated that many different forms, embodiments and combinations are possible without deviating from the spirit and teachings of this disclosure and so this disclosure should not be construed as limited to the example embodiments set forth herein. Rather, these examples and embodiments are provided so that this disclosure will be thorough and complete, and will convey the scope of the disclosure to those skilled in the art.

The embodiments disclosed herein are related generally to vibration isolation assemblies (also referred to herein as “pneumatic vibration isolators”, “vibration isolators”, or “isolators”). One particular application for vibration isolation assemblies is in optical table systems. A typical optical table system comprises an optical table top and one or more vibration isolation assemblies (e.g., four) operative to support the optical table top. Optical table tops are often constructed of upper and lower plates with a honeycomb core positioned between the plates, providing a rigid structure having a low weight relative to its size and stiffness. Optical table systems are used for experiments involving lasers, optical components (e.g., lenses, mirrors, prisms), optical measurement instruments (e.g., optical detectors, power meters, cameras), among other equipment. Such experiments are particularly sensitive to vibration, and the vibration isolation assemblies described herein are used to prevent vibration (also referred to herein as “input vibration” or “excitation vibration”) of the floor (e.g., due to human footsteps, the movement of building elevators, passing vehicles, and rotating machinery such as electric motors) from reaching the equipment mounted on the optical table top. Additionally, the vibration isolation assemblies described herein are also used to prevent or reduce vibration from the optical table top to the floor or other supporting surface (e.g., another optical table top). Excitation vibrations occur at a variety of frequencies or frequency ranges, depending on the source, that are generally measured in Hertz (Hz). The term “transmissibility” used herein is defined as the amount of the excitation vibration transferred from one mass to another (e.g., from the floor to the optical table top, or vice-versa).

FIG. 1 shows a schematic cross-section view of a vibration isolation assembly 10. The vibration isolation assembly 10 includes a housing 14 defining a single pneumatic chamber 16 having a volume V in pneumatic communication with a pressure source (not shown). The chamber 16 is sealed by a diaphragm 12 that engages and supports a mass engaging member 22 configured to support a payload 24 having a mass mi. The vibration isolation assembly 10 is supported by a supporting surface 20. During operation, the pneumatic chamber 16 acts as a spring to prevent the transmission of vibration between the supporting surface 20 and the payload 24. The vibration isolation assembly 10 is also referred to herein as a “single-chamber isolator 10”.

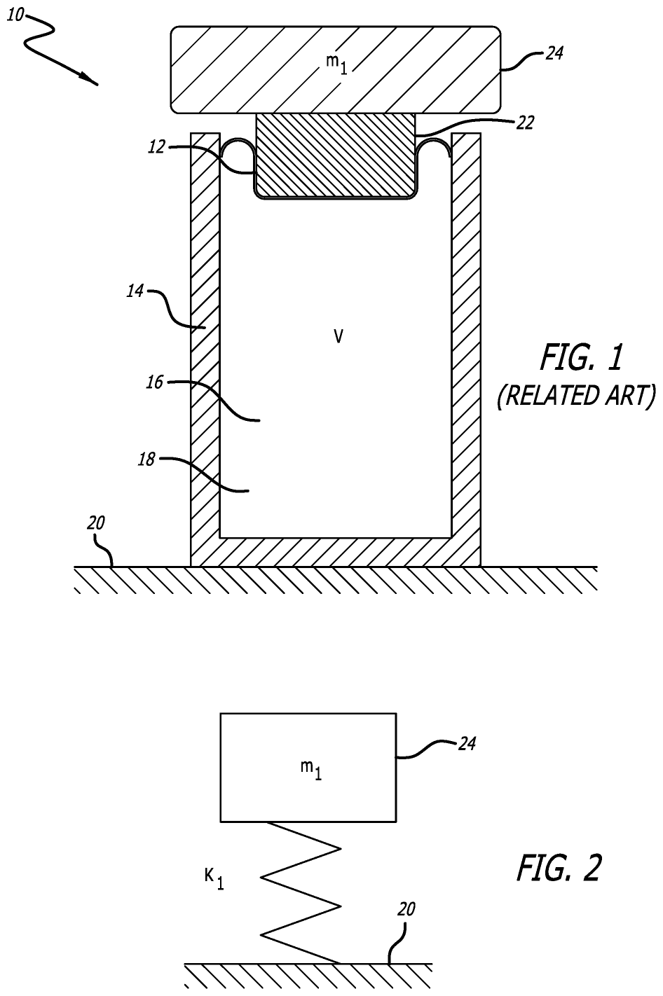

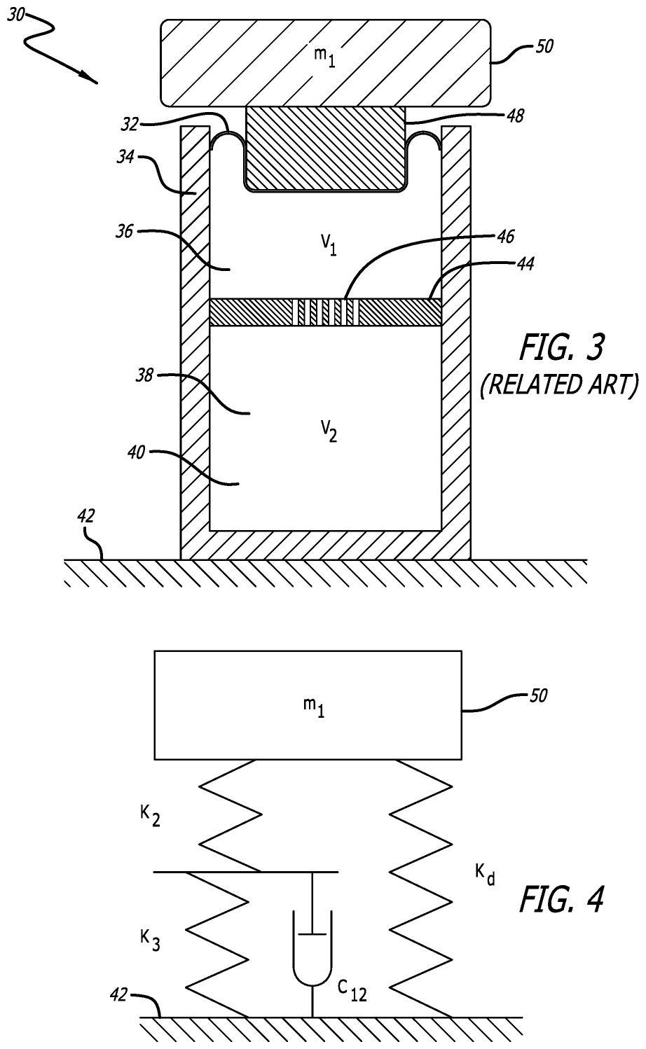

FIG. 2 shows a mechanical model of the single-chamber isolator 10 with the payload 24 having mass m₁, wherein the combined stiffness of the pneumatic chamber and the diaphragm is denoted K₁. Referring back to FIG. 1, a known drawback of the design of the single-chamber isolator 10 is that some vibrational excitation of the supporting surface 20, or a transient excitation of the supporting surface 20 may cause excessive resonance vibration of the payload 24 at the resonance frequency of the oscillator defined by the stiffness K₁ and mass m₁.

FIG. 3 shows a schematic cross-section view of a vibration isolation assembly 30 (also referred to herein as a “two-chamber isolator 30”) that includes a vibration damping feature provided as a flow resistance orifice 46 configured to provide pneumatic communication between two pneumatic chambers. The vibration isolation assembly 30 includes a housing 34 and a partition 44, defining a first pneumatic chamber 36 (also known as a “compliance chamber”) having a volume V₁ and a second pneumatic chamber 38 (also known as a “damping chamber”) having a volume V₂. The first pneumatic chamber 36 and the second pneumatic chamber 38 are in pneumatic communication with each other via a flow resistance orifice 46 that is designed to provide a viscous flow of gas between the chambers 36 and 38. The first chamber 36 is sealed by a diaphragm 32 that supports a mass engaging member 48 (e.g., a piston) configured to support a payload 50 (e.g., an optical table top, or a portion of an optical table top) having a mass m₁. The vibration isolation assembly 30 is supported by a supporting surface 42 (e.g., a floor). During operation, the pneumatic chambers 36 and 38 act as springs to prevent the transmission of excitation vibrations between the payload 50 and the supporting surface 42, effectively isolating the payload from excitation vibrations from the supporting surface 42. The flow resistance orifice 46 provides energy dissipation to prevent or reduce excessive resonance vibration.

FIG. 4 shows a mechanical model of the two-chamber isolator 30 with a payload 50 having mass m₁. Here, K₂ represents the stiffness of the upper chamber 36, K₃ represents the stiffness of the lower chamber 38, C₁₂ represents the viscosity of the gas moving through the orifice 46, and K_{d} represents the stiffness of the diaphragm 32. The dynamic stiffness of the two-chamber pneumatic isolator 30 has two limiting values. At low excitation frequencies (f→0) the resistance to gas flow through the flow resistance orifice 46 is low, and the dynamic stiffness K(f) of the two-chamber isolator 30 assumes a lowest value, K_{L}, which corresponds to the first chamber 36 and the second chamber 38 acting as a single chamber. At higher excitation frequencies, the resistance to gas flow through the flow resistance orifice 46 grows, and the dynamic stiffness K(f) of the two-chamber isolator 30 approaches a highest limiting value, K_{H}, which corresponds to the first chamber 36 acting alone. As a result, at lower excitation frequencies, a two-chamber isolator acts like a more effective high-volume (e.g., having a volume equal to V₁+V₂) isolator with a low natural frequency, whereas at higher excitation frequencies, the two-chamber isolator acts as a less effective low-volume isolator (e.g., having a volume equal to Vi) with higher natural frequency.

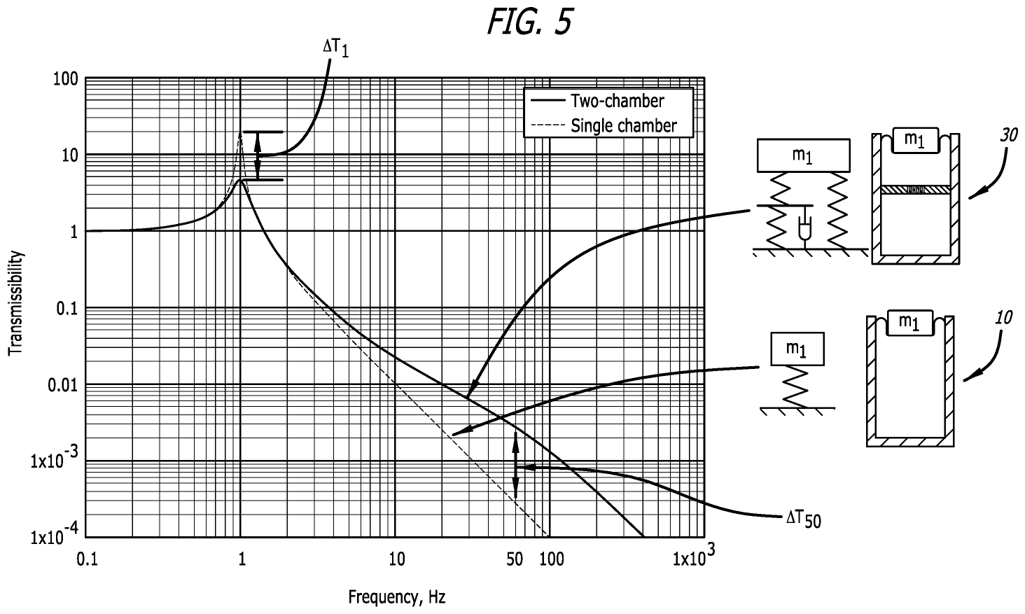

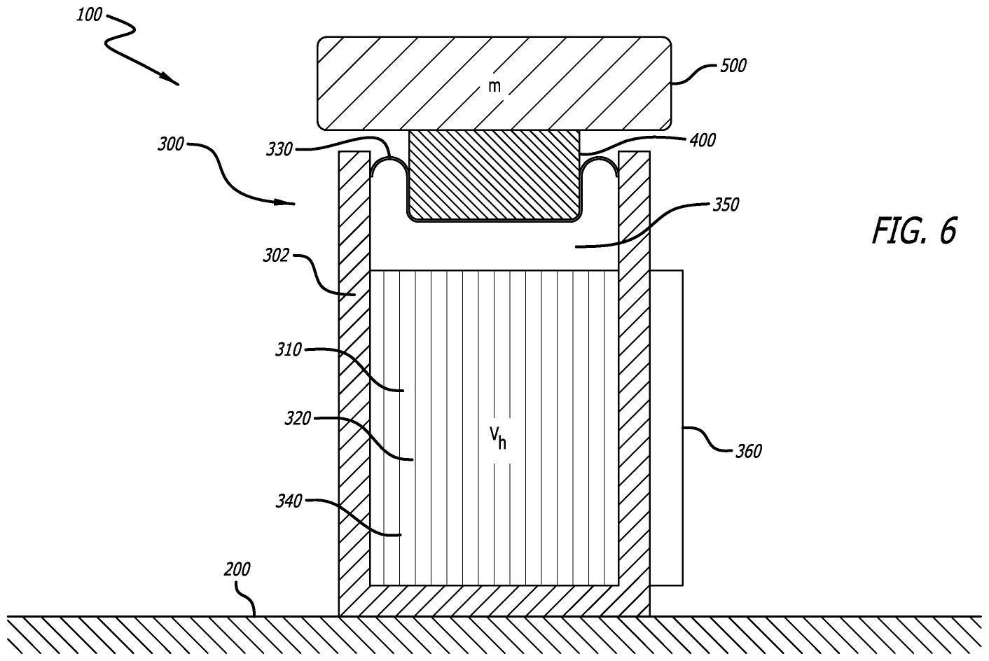

FIG. 5 shows a graph of vibration transmissibility between the supporting surface and the payload as a function of the frequency (f) of the excitation vibration for a constant mass =mi and illustrates the tradeoff between damping of resonance vibration and vibration isolation performance at higher frequencies. FIG. 5 shows the transmissibility curve of the vibration isolation assembly 10 having a payload mi (shown by the dashed line), and the transmissibility curve for the vibration isolation assembly 30 having the same payload mi and the same total air volume (shown by the solid line). At an excitation frequency f=50 Hz, the transmissibility of the single-chamber isolator 10 is about 3×10⁻³, while the transmissibility of the two-chamber isolator 30 is about 3×10⁻². This gives a difference in transmissibility, ΔT₅₀=10 on the logarithmic scale between the vibration isolators 10 and 30, which is an order of magnitude (10×) difference.

At the resonance frequency of f=1 Hz, the transmissibility of the single-chamber isolator 10 is approximately 20 and the transmissibility of the two-chamber isolator 30 is approximately 5. This gives a difference in transmissibility at 1 Hz, ΔT₁=4. This represents a 4× difference between the transmissibility of the single-chamber isolator 10 and the two-chamber isolator 30. In most applications, such high transmissibility at the resonant frequency is unacceptable, so a two-chamber isolator design is favored because it provides damping, whereas a single-chamber isolator design does not provide damping, and the better isolation performance at higher frequencies of the single-chamber isolator 10 is not worth the tradeoff of poor isolation performance at resonance. It is important to note that the transmissibility curves shown in FIG. 5 are typical of single-chamber isolator and two-chamber isolator designs. Exact transmissibility curves and the frequency response of single-chamber isolator and two-chamber isolator designs can vary depending on the mass of the payload and on a variety of other conditions.

FIG. 6 shows a schematic cross-section view of an embodiment of a vibration isolation assembly 100 configured to prevent or reduce the transmission of excitation vibration between a supporting surface and a payload at high vibration excitation frequencies, while providing improved performance, as compared to the performance of the vibration isolation assembly 10, at low frequencies. In this embodiment, the vibration isolation assembly 100 includes a housing assembly 300 having a housing body 302 with a pneumatic chamber 310 having a volume Vₕ in pneumatic communication with a pressure source (not shown) formed therein. Although the embodiment shown in FIG. 6 includes a single pneumatic chamber formed within the housing body 302, those skilled in the art will appreciate that any number of pneumatic chambers of any variety of size, shape, and/or transverse dimension may be formed within the housing body 302. The pneumatic chamber 310 is sealed by a diaphragm 330 that engages and supports a mass engaging member 400 (e.g., a piston) movably coupled to the housing body 302 and configured to support and adjust the vertical position of a payload 500 (e.g., an optical table or a portion of an optical table) having a mass m. The housing body 302 and the mass engaging member 400 may be formed from a variety of materials, including, without limitation, aluminum, steel, stainless steel, copper, brass, bronze, polymer, composite materials, and ceramic materials. In one embodiment, the mass m is about 500 kilograms, though those skilled in the art will appreciate that that the vibration isolation assembly 100 may be configured to support payloads having a wide variety of masses. In this embodiment, the pneumatic chamber 310 is configured to accept a thermally conductive compressible fluid 320 at a pressure selected to support the mass engaging member 400 and the payload 500. In this embodiment, the fluid 320 is air, though those skilled in the art will appreciate that any compressible fluid (e.g., inert gases such as argon, helium, nitrogen, etc.) can be used. In another embodiment, the fluid 320 may comprise a liquid. As such, the pneumatic chamber 302 may instead comprise a hydraulic chamber. In another embodiment the fluid 320 may comprise both a gas and a liquid. As such, in another embodiment, the pneumatic chamber 320 may form a fluid chamber configured to support the mass engaging member 400 that is movably coupled to the housing body 302. The vibration isolation assembly 100 is supported by a supporting surface 200 (e.g., a floor or other structure). The vibration isolation assembly 100 further includes at least one thermally conductive member 340 positioned in the pneumatic chamber 310 in thermal communication with the housing body 302 and configured to absorb thermal energy created in the pneumatic chamber 310 from compression of the fluid 320 and transfer that thermal energy to the housing body 302 where it is transferred into the ambient environment. Thermal energy may be transferred away from the housing body 302 may be transferred to the ambient environment by radiation, free convection, or forced convection (e.g., a fan directed at the housing body 302). Generally, the thermally conductive member 340 is configured to place a thermally conductive material in close contact with as much of the fluid 320 as possible. In this embodiment, the thermally conductive member 340 takes up about 90% of the volume Vₕ, and the remaining volume is denoted in FIG. 6 as volume 350. The vibration isolation assembly 100 having the thermally conductive member 340 may be also referred to herein as a “thermally conductive isolator 100”. In some embodiments, the mass engaging member 400 may be positioned in thermal communication with the payload 500 so that the mass engaging member 400 can absorb thermal energy from the pneumatic chamber 310 and transmit it to the payload 500 and/or the ambient environment.

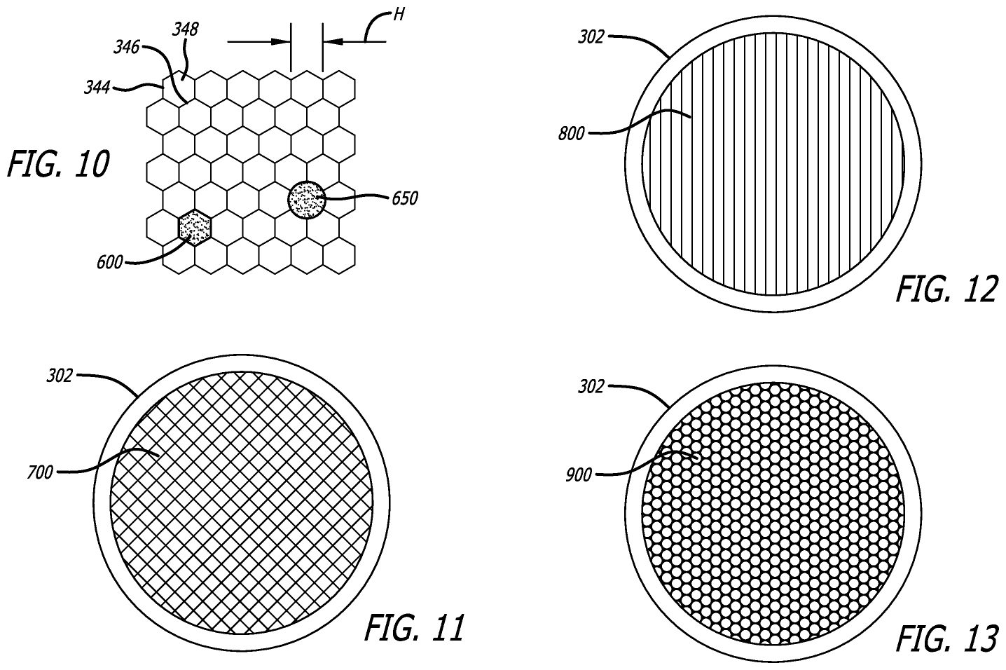

The thermally conductive member 340 is configured to absorb the thermal energy that is created in the volume Vₕ when the fluid 320 is dynamically compressed in process of vibrational changes of the air volume when the mass engaging member 400 moves vertically while supporting the payload 500. Since air or other gases that may be used as the fluid 320 are poor conductors of heat, the thermally conductive member 340 is configured to place a thermally conductive material (e.g., a metal such as aluminum) as close as possible to as much of the fluid volume as possible, effectively increasing the thermal conductivity of the air in the pneumatic chamber 310. To do so, the thermally conductive member 340 is generally provided as a porous thermally conductive structure that transfers the thermal energy created in the volume Vₕ of the pneumatic chamber 310 to the housing body 302, whereupon the thermal energy is transferred to the ambient environment. The thermally conductive member 340 may be provided as a thermally conductive body having a plurality of channels formed therein. In this embodiment, the thermally conductive member 340 is provided as a honeycomb structure (such as that shown in FIG. 10), having hexagonal passages oriented parallel to the vertical motion of the mass engaging member 400. Though most honeycomb structures have cells with hexagonal shapes or geometries, the term “honeycomb” used when describing the embodiments herein should not be construed as limited to hexagonal shapes or geometries, and as such may also have other shapes or geometries. The honeycomb structure may be formed from any variety of materials, including, without limitation, aluminum, steel, stainless steel, copper, copper-tungsten, brass, bronze, polymers, composite materials, ceramic materials and nanostructured materials (e.g., carbon nanotubes).

FIG. 10 shows close-up plan cross-section of an embodiment of the honeycomb structure used to form the thermally conductive member 340 positioned in the housing body 302. The honeycomb structure includes a plurality of cells 344 that extend vertically through the pneumatic chamber 310. Each cell 344 defines a pneumatic volume 348 and shares at least one thermally conductive cell wall 346 with at least one adjacent cell, so that thermal energy can be conducted along the walls of each cell to the walls of adjacent cells and eventually to the housing body 302 where it is radiated, conducted, or convected into the ambient environment. In this embodiment, each cell 344 has a width H, though in some embodiments individual cells may have different widths. When configured as such, each fluid molecule in each pneumatic volume 348 is positioned no more than a distance of H/2 away from a thermally conductive cell wall 346, effectively increasing the thermal conductivity of the gas within the pneumatic chamber 310 shown in FIG. 6. In this embodiment, the width of the cells is 6 millimeters, meaning that all of the fluid molecules within the honeycomb structure are no more than about 3 millimeters from the thermally conductive material forming the cells walls 346. In the illustrated embodiment, each cell 344 has the same width, though in other embodiments, the cells 344 may have different widths.

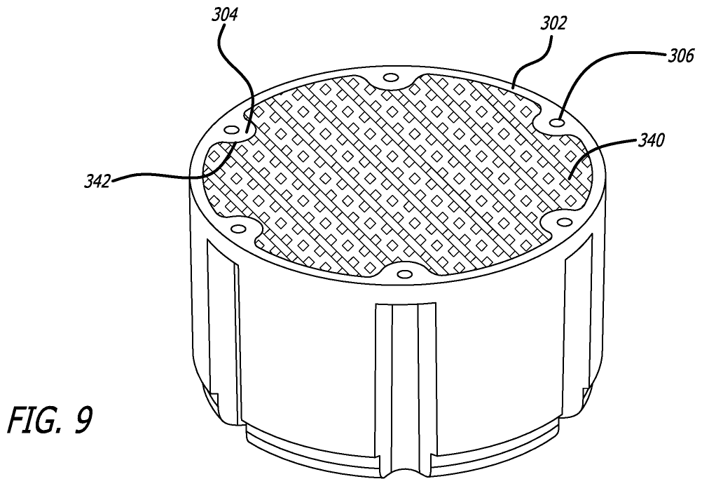

In one embodiment, as shown in FIG. 9, the thermally conductive member 340 is placed in direct contact with the housing body 302 by pressing the honeycomb structure into the housing body 302 so that some of the outer honeycomb cells 344 are deformed at the nexus between the housing body 302 and the thermally conductive member 340, thereby providing sufficient thermal contact between the thermally conductive member 340 and the housing body 302. In another embodiment, the thermally conductive member 340 is bonded to the housing body 302 by a thermally conductive adhesive (not shown). In another embodiment, air or another fluid may be forced (e.g., by a fan) through the pneumatic volumes 348 of each cell 344 in order to convect the thermal energy away from each cell 344 to the housing body 302. In another embodiment, air or another fluid may be drawn (e.g., by a fan or vacuum pump) through the pneumatic volumes 348 of each cell 344 in order to advect the thermal energy away from each cell 344 to the housing body 302. In another embodiment, the fluid 320 may be circulated through different cells 344 by a variety of different devices or methods. In this embodiment, (referring to FIG. 6) the combined volume of air in the honeycomb cells is about 90% of the total volume Vₕ of the pneumatic chamber 310, while the remaining volume 350 above the thermally conductive member 340 provides sufficient room to allow the mass engaging member 400 to move vertically during operation. The respective percentages of the volume of air in the honeycomb cells 344 and the remaining volume 350 may be tailored to provide optimal isolation performance for a variety of applications. For example, in one embodiment, for a vibration environment where the excitation frequency expected to be in the 40-55 Hz range, this proportion may be 90%/10%. In another embodiment, for a vibration environment where the excitation frequency is expected to be in the 56-70 Hz range, this proportion may be 80%/20%.

In an alternate embodiment, as shown in FIG. 10, one or more thermal conductors, such as the hexagonally shaped conductor 600, may be placed inside one or more of the honeycomb cells 344. In another embodiment, one or more thermal conductors 650 having a circular cross-section may be inserted into the thermally conductive member 340 to increase the rate of heat transfer from the thermally conductive member 340 to the housing body 302. In one embodiment, the thermal conductors 600, 650 may be provided as solid metal (e.g., copper) rods. In another embodiment, the conductors 600, 650 may be provided as a heat pipes. Those skilled in the art will appreciate that any type or number of thermal conductors may be placed in the thermally conductive member 340.

While the cells 344 in the illustrated embodiment shown in FIG. 10 are hexagonally shaped, in other embodiments, the cells 344 may have square, rectangular, triangular, pentagonal, octagonal, trapezoidal, circular, oval, or elliptical shapes. In other embodiments the cells 344 may be star-shaped or randomly-shaped. Those skilled in the art will appreciate that the cells 344 may be formed in many varieties of shapes configured to maximize or tailor the heat transfer from the fluid 320 inside the pneumatic chamber 310 to the housing 304 and into the ambient environment. While the possible shapes listed above may denote exact geometry, those skilled in the art will appreciate that manufacturing methods may result in shapes that approximate the shapes listed above, without deviating from the spirit and teachings of this disclosure.

Referring back to FIG. 6, the thermally conductive member 340 may be formed from a wide variety of materials having different thermal conductivities and different mechanical configurations. Exemplary materials for the thermally conductive member 340 include, without limitation, aluminum, steel, stainless steel, copper, copper-tungsten, brass, bronze, polymers, diamond, composite materials, ceramic materials and nanostructured materials (e.g., carbon nanotubes). Thermal conductivity is measured in watts/meter-degree Kelvin (W/mK). The thermal conductivity of air is approximately 0.026 W/mK. The thermal conductivity of aluminum is between 237-247 W/mK, about 9,000 times that of air. The thermal conductivity of copper is 398/390 W/mK. The thermal conductivity of tungsten is about 173 W/mK. Also, the thermally conductive member 340 may be formed from a wide variety of materials having different specific heat capacities, measured in joules/kg-degree Kelvin (J/kg-K). For example, in one embodiment, the thermally conductive member 340 may be made from aluminum having a specific heat capacity of about 920 J/kg-K. In another embodiment, the thermally conductive member 340 may be made from copper having a specific heat capacity of about 377 J/kg-K. Those skilled in the art will appreciate that the thermally conductive member 340 may be made of materials with any variety of specific heat capacities.

Referring back to FIG. 6, in some embodiments, to maximize the transfer of thermal energy from the housing body 302 to the ambient environment, one or more additional thermally conductive members or devices 360 may be placed in thermal contact with the outer surface of the housing body 302. In one embodiment, the thermally conductive device 360 is provided as a heat sink attached to the exterior surface of the housing body 302. The heat sink 360 may include a plurality of cooling fins (not shown). Exemplary materials for the heat sink 360 include metals having a high thermal conductivity (e.g., aluminum, copper, bronze, copper-tungsten, magnesium and the like or any combination thereof), or metals with a combination of high heat capacity and high thermal conductivity, such as copper or copper-tungsten. In one embodiment, the heat sink 360 is a single passive device, transferring thermal energy into the ambient environment by radiation or free convection. In another embodiment, the heat sink 360 may include one or more fans operative to direct a flow of air over the heat sink 360 to transfer thermal energy into the ambient environment by forced convection. In another embodiment, the heat sink 360 may include one or more thermoelectric coolers. In still another embodiment, a thermally conductive member may be placed between the housing body 302 and the supporting surface 200 so that thermal energy from the housing body 302 can be conducted to the supporting surface 200 and into the ambient environment. Those skilled in the art will appreciate that any type or any number of heat sinks or other heat transfer devices may be placed in thermal communication with the housing body 302 and the ambient environment.

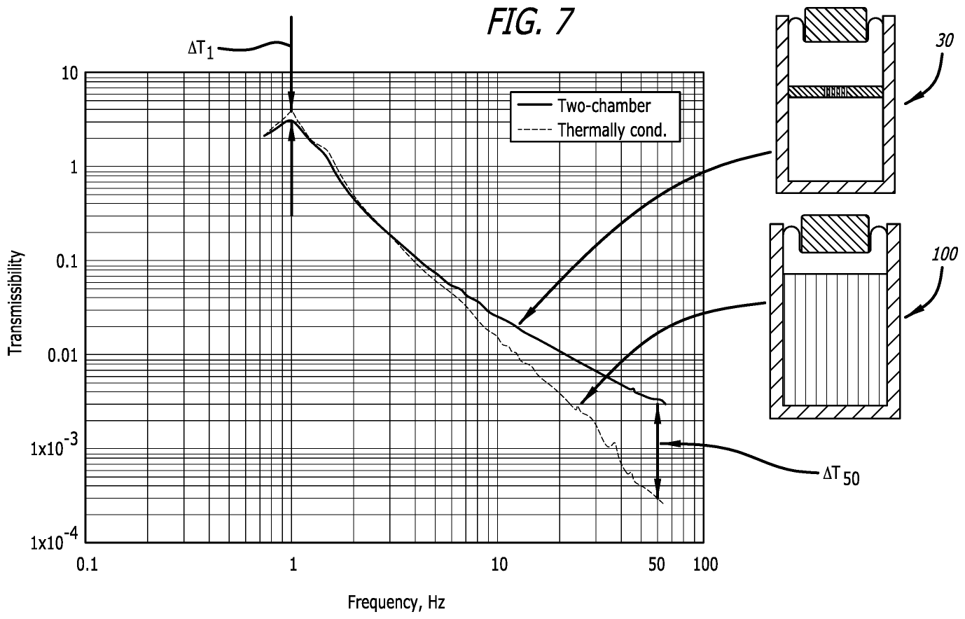

FIG. 7 shows an experimental graph of vibration transmissibility between a supporting surface and the payload as a function of the frequency of the excitation vibration, to compare the transmissibility of the two-chamber isolator 30 and at least one embodiment of the thermally conductive isolator 100, as described with respect to FIG. 6. Both isolators have the same total air volume and support the same load. The transmissibility of the vibration isolation assembly 100 is less than that of a two-chamber isolator 30 starting at excitation frequencies of about 4 Hz. At approximately 50 Hz, the transmissibility of the vibration isolation assembly 100 is about 2×10⁻⁴, while the transmissibility of the vibration isolation assembly 30 is about 2×10⁻³. This is a difference in transmissibility at 50 Hz , ΔT₅₀=10 on the logarithmic scale, which is an order of magnitude (10×) difference.

At resonant frequencies around 1 Hz, the thermally conductive isolator 100 has a transmissibility of about 4, and the two-chamber isolator 30 has a transmissibility of about 3. This gives a difference in transmissibility at 1 Hz, ΔT₁=1.33, meaning that the thermally conductive isolator 100 has approximately 1.33× the transmissibility of the two-chamber isolator 30 at resonance. In many applications, such a tradeoff is acceptable, because the thermally conductive isolator 100 has only slightly greater transmissibility than the two-chamber isolator at resonance, but has 10× lower transmissibility than the two-chamber isolator at 50 Hz.

The transmissibility curve of the thermally conductive isolator 100 shown in FIG. 7 is illustrative of only one embodiment of the thermally conductive isolator 100. The thermally conductive isolator 100 may have any variety of transmissibility curves, or frequency/isolation responses to excitation vibration, depending on a wide variety of factors, including the mass of the payload, the exact design of the thermally conductive isolator 100 and on a variety of other conditions. For example, in some embodiments, the thermally conductive isolator 100 may have a resonant frequency between 1 and 50 Hz, or may experience resonance at excitation frequencies between 1 Hz and 50 Hz. In some embodiments, the excitation vibration may be a multiple of a resonant frequency. For example, in one embodiment, the excitation vibration may be between 5-10 times the resonant frequency, though those skilled in the art will appreciate that the excitation vibration may any multiple of the resonant frequency. In one embodiment, the thermally conductive isolator 100 may be configured to provide lower transmissibility (e.g., relative to a two-chamber isolator) at excitation vibration frequencies ranging from 2 Hz to 20 Hz. In another embodiment, the thermally conductive isolator 100 may be configured to provide lower transmissibility at excitation vibration frequencies ranging from 5 Hz to 50 Hz. In other embodiments, the thermally conductive isolator 100 may be configured to provide lower transmissibility at excitation vibration frequencies ranging from 50 Hz to 500 Hz. Those skilled in the art will appreciate that the thermally conductive isolator 100 may provide improved isolation performance relative to two-chamber isolators at any excitation vibration frequency, range of frequencies, or frequency bands.

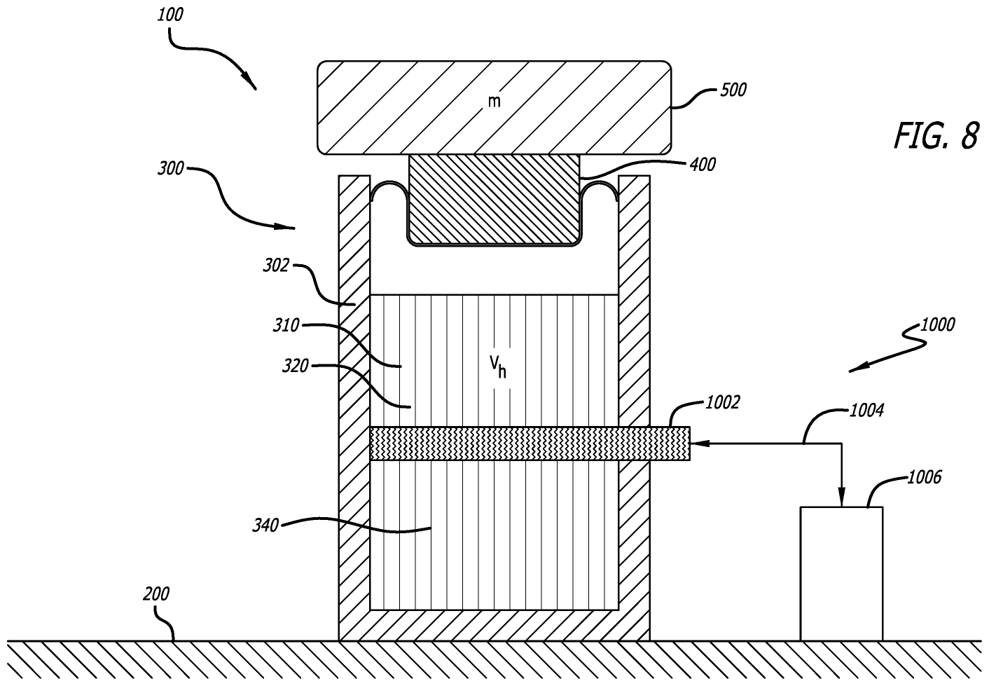

FIG. 8 shows a schematic cross-section view of an embodiment of the thermally conductive pneumatic isolator 100 having an active heat transfer system, such as the thermal management system 1000, placed in thermal communication with the thermally conductive member 340. In this embodiment, the vibration isolation assembly 100 has generally the same configuration as described with respect to FIG. 6, with a housing assembly 300 having a housing body 302 defining a pneumatic chamber 310 having a volume Vₕ, filled with a compressible fluid 320 at a pressure selected to support a payload 500. The housing assembly 300 rests on a supporting surface 200, and has a mass engaging member 400 supporting the payload 500 (e.g., an optical table or a portion of an optical table) having a mass m. In this embodiment, the thermal management system 1000 includes a heat transfer device 1002 extending into the pneumatic chamber 310 and the thermally conductive member 340. In this embodiment, the heat transfer device 1002 does not block the fluid 320 from flowing from the region above heat transfer device 1002 to the region below the heat transfer device 1002. Exemplary heat transfer devices 1002 include, without limitation, air-to-air heat exchangers, air-to-water heat exchangers, heat pipes, heat pumps, forced air convection systems, thermoelectric coolers, and the like or any combination thereof. In this embodiment, the heat transfer device 1002 is in fluid and thermal communication with a secondary heat transfer device 1006 (e.g., a chiller) via a conduit, tube, or pipe 1004.

FIGS. 9-13 show various embodiments of thermally conductive members that may be placed in the housing body 302 of the thermally conductive isolator 100. FIG. 9 shows an embodiment of the housing body 302 with the thermally conductive member 340 provided as a honeycomb structure. In this embodiment, the housing body 302 includes a plurality of extended regions 304 formed in the housing body 302, with each extended region 304 having a fastener passage 306 formed therein, with the fastener passages 306 configured to accept fasteners (not shown) used to secure the housing body 302 to other components of the vibration isolation assembly 100. A plurality of reliefs 342 are formed in the thermally conductive member 340, with each relief 342 corresponding to an extended region 304 of the housing body 302, so that the physical and thermal contact between the thermally conductive member 340 and the inner surface of the housing body 302 is maximized.

FIG. 10 shows close-up plan cross-section of an embodiment of the honeycomb structure used to form the thermally conductive member 340 positioned in the housing body 302. This embodiment shown in FIG. 10 is described in greater detail above with respect to FIG. 6. The honeycomb structure includes a plurality of cells 344 that extend vertically through the pneumatic chamber 310. Each cell 344 defines a pneumatic volume 348 and shares at least one thermally conductive cell wall 346 with at least one adjacent cell, so that thermal energy can be conducted along the walls of each cell to the walls of adjacent cells and eventually to the housing body 302 where it is radiated, conducted, or convected into the ambient environment. In this embodiment, each cell 344 has a width H, though in some embodiments individual cells may have different widths.

FIG. 11 shows a plan section view of the housing body 302 having a thermally conductive member 700 placed therewithin. In one embodiment, the thermally conductive member 700 is formed from a wire mesh or wire wool configured to absorb thermal energy within the pneumatic chamber 310 and conduct it to the housing body 302. In another embodiment, the thermally conductive member 700 may be formed from a plurality of square tubes or other square members having air volumes formed therein, with the tubes or square members being configured to absorb thermal energy within the pneumatic chamber 310 and conduct it to the housing body 302. In another embodiment, the thermally conductive member 700 may be formed from a porous metal foam or other porous foam formed from a thermally conductive material that allows the fluid 320 to circulate between its cells so that thermal energy created in the pneumatic chamber 310 is conducted to the housing body 302.

FIG. 12 shows a plan section view of the housing body 302 having a thermally conductive member 800 placed therewithin. In one embodiment, the thermally conductive member 800 is formed from plurality of thermally conductive plates (e.g., formed from aluminum or other thermally conductive material) configured to absorb thermal energy within the pneumatic chamber 310 and conduct it to the housing body 302. In another embodiment, the thermally conductive member 800 may be formed from a plurality of heat sinks positioned in the housing body 302 and configured to absorb thermal energy within the pneumatic chamber 310 and conduct it to the housing body 302.

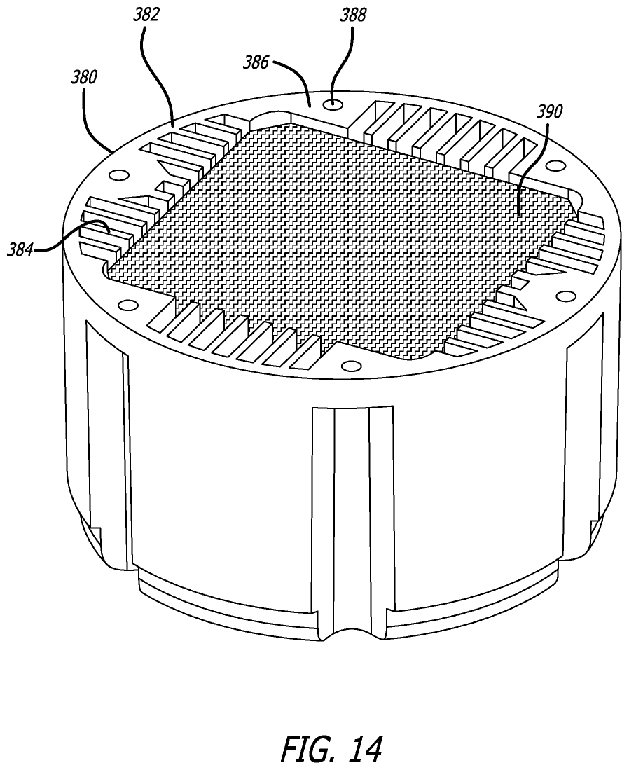

FIG. 13 shows a plan section view of the housing body 302 having a thermally conductive member 900 placed therewithin. In one embodiment, the thermally conductive member 900 is formed from a plurality of circular tubes or pipes placed in thermal communication with each other, each tube or pipe having an air volume formed therein, with the circular tubes or pipes being configured to absorb thermal energy within the pneumatic chamber 310 and conduct it to the housing body 302.

FIG. 14 shows an embodiment of a housing 380 that may be used in the thermally conductive isolator 100. In this embodiment, the housing 380 includes a housing body 382 having a thermally conductive member 390 placed therewithin. In this embodiment, the housing body 382 includes a plurality of extended regions 386 formed in the housing body 382, with each extended region 386 having a fastener passage 388 formed therein, with the fastener passages 388 configured to accept fasteners (not shown) used to secure the housing body 382 to other components of the thermally conductive isolator 100. A plurality of heat transfer members 384 (e.g., cooling fins) are formed on at least one interior surface of the housing body 382, with the heat transfer members 384 configured to conduct thermal energy from the thermally conductive member 390 (and elsewhere in the pneumatic chamber 310 of the vibration isolation assembly 100) to the exterior of housing body 382 where the thermal energy is dissipated into the ambient environment. The thermally conductive member 390 may be formed of any of the materials or configurations described above with respect to the thermally conductive member 340. In an alternate embodiment, the heat transfer members 384 may extend further into the housing body 382 and may be configured so they collectively provide enough thermal conductivity for the air in the pneumatic chamber 310 so that a separate thermally conductive member 390 is not required. As such, the plurality of heat transfer members 384 may effectively form a thermally conductive member that is formed monolithically with the housing body 382. In other embodiments, the thermally conductive member 390 may be provided as a 3D-printed structure either formed separate from or monolithically with the housing body 382.

The foregoing is illustrative of embodiments and examples of the invention, and is not to be construed as limiting thereof. Although a few specific embodiments and examples have been described with reference to the drawings, those skilled in the art will readily appreciate that many modifications to the disclosed embodiments and examples, as well as other embodiments, are possible without materially departing from the novel teachings and advantages of the invention. Accordingly, all such modifications to the subject matter described herein are intended to be included within the scope of the invention as defined in the claims. For example, skilled persons will appreciate that the subject matter of any sentence, paragraph, example or embodiment can be combined with subject matter of some or all of the other sentences, paragraphs, examples or embodiments, except where such combinations are mutually exclusive. The scope of the present invention should, therefore, be determined by the following claims, with equivalents of the claims to be included therein.

What is claimed is:

1. A vibration isolation assembly configured to reduce the communication of at least one excitation vibration between at least one supporting surface and at least one payload, comprising:
at least one housing assembly having at least one housing body with at least one pneumatic chamber formed therein, the at least one pneumatic chamber configured to accept at least one fluid, wherein the at least one housing assembly is supported by the at least one supporting surface;
at least one mass engaging member supported by the at least one pneumatic chamber, the at least one mass engaging member configured to support at least a portion of the at least one payload;
at least one first thermally conductive member positioned within the at least one pneumatic chamber, the at least one first thermally conductive member in thermal communication with the at least one housing body;
wherein the at least one first thermally conductive member is configured to transfer thermal energy from the at least one fluid in the at least one pneumatic chamber to the at least one housing body.

2. The vibration isolation assembly of claim 1, wherein the at least one first thermally conductive member is at least one honeycomb structure.

3. The vibration isolation assembly of claim 2, wherein the at least one honeycomb structure is metallic.

4. The vibration isolation assembly of claim 1, wherein the at least one first thermally conductive member includes at least one thermally conductive body with a plurality of channels formed therein.

5. The vibration isolation assembly of claim 4, wherein the channels formed in the at least one first thermally conductive member have a shape selected from the group consisting of square, rectangular, triangular, pentagonal, hexagonal, octagonal, trapezoidal, circular, elliptical, oval.

6. The vibration isolation assembly of claim 1, wherein the at least one first thermally conductive member is formed from at least one metal mesh.

7. The vibration isolation assembly of claim 1, wherein the at least one first thermally conductive member is formed from a plurality of metal tubes.

8. The vibration isolation assembly of claim 1, wherein the at least one first thermally conductive member is at least one heat sink.

9. The vibration isolation assembly of claim 1, wherein the at least one first thermally conductive member is formed from at least one ceramic material.

10. The vibration isolation assembly of claim 1, wherein the at least one excitation vibration has a frequency between 5 and 30 Hz.

11. The vibration isolation assembly of claim 1, wherein the at least one excitation vibration has a frequency between 30 and 70 Hz.

12. The vibration isolation assembly of claim 1, wherein the at least one excitation vibration has a frequency between 70 Hz and 150 Hz.

13. The vibration isolation assembly of claim 1, wherein the at least one excitation vibration has a frequency between 100 Hz and 200 Hz.

14. The vibration isolation assembly of claim 1, wherein the at least one excitation vibration has a frequency between 100 Hz and 500 Hz.

15. The vibration isolation assembly of claim 1, wherein the vibration isolation assembly has a resonant frequency between about 1 Hz and 5 Hz.

16. The vibration isolation assembly of claim 15, wherein the at least one excitation vibration is about five times that of a resonant frequency.

17. The vibration isolation assembly of claim 15, wherein the at least one excitation vibration is about ten times that of a resonant frequency.

18. The vibration isolation assembly of claim 1, wherein the at least one payload is at least one optical table top.

19. The vibration isolation assembly of claim 1, further comprising at least one second thermally conductive member secured to at least one outer surface of the housing body.

20. The vibration isolation assembly of claim 19, wherein the at least one second thermally conductive member is at least one heat sink.

21. The vibration isolation assembly of claim 1, wherein at least one of the at least one housing body and the at least one mass engaging member are formed from a material selected from a group consisting of aluminum, steel, stainless steel, copper, brass, bronze, polymer, composite materials, and ceramic materials.

22. The vibration isolation assembly of claim 1, wherein the at least one first thermally conductive member is formed from a material selected from a group consisting of aluminum, steel, stainless steel, copper, copper-tungsten, brass, bronze, polymers, diamond, composite materials, and ceramic materials.

23. The vibration isolation assembly of claim 1, wherein the at least one pneumatic chamber is placed in thermal communication with at least one thermally conductive fluid that is in contact with at least one outer surface of the at least one housing body.

24. The vibration isolation assembly of claim 1, wherein the at least one first thermally conductive member is at least one 3D-printed structure in thermal communication with the at least one housing body.

25. The vibration isolation assembly of claim 1, wherein the at least one first thermally conductive member is formed monolithically with the at least one housing body.

26. The vibration isolation assembly of claim 1, wherein the at least one first thermally conductive member is at least one 3D-printed structure formed monolithically with the at least one housing body.

27. The vibration isolation assembly of claim 1 wherein the at least one first thermally conductive member is in thermal communication with the at least one mass engaging member.

28. The vibration isolation assembly of claim 1 wherein the at least one first thermally conductive member is in thermal communication with the at least one payload.

29. The vibration isolation assembly of claim 1 wherein the thermal energy is transferred away from the at least one housing body by forced convection.

30. The vibration isolation assembly of claim 1 wherein the thermal energy is transferred away from the at least one housing body by free convection.

31. The vibration isolation assembly of claim 1 wherein the thermal energy is transferred away from the at least one housing body by radiation.

32. The vibration isolation assembly of claim 1 further comprising at least one thermal management system configured to remove thermal energy from the at least one housing body.

33. The vibration isolation assembly of claim 32, wherein the at least one thermal management system includes at least one heat exchanger.

34. The vibration isolation assembly of claim 33, wherein the at least one heat exchanger is in fluid communication with at least one secondary heat transfer device.

35. The vibration isolation assembly of claim 33, wherein the at least one heat exchanger is at least one air-to-air heat exchanger.

36. The vibration isolation assembly of claim 33, wherein the at least one heat exchanger includes at least one thermoelectric cooler.

37. The vibration isolation assembly of claim 1 wherein the at least one mass engaging member is configured to adjust the vertical position of the at least one payload.

38. The vibration isolation assembly of claim 1 wherein the at least one mass engaging member is configured to absorb thermal energy from the at least one pneumatic chamber.

39. A vibration isolation assembly, comprising:
at least one housing assembly having at least one housing body with at least one fluid chamber formed therein, the at least one fluid chamber configured to accept at least one fluid therein;
at least one mass engaging member movably coupled to the at least one housing body and supported by the at least one fluid chamber, the at least one mass engaging member configured to support at least a portion of at least one payload;
at least one first thermally conductive member positioned within the at least one fluid chamber, the at least one first thermally conductive member in thermal communication with the at least one housing body and configured to transfer thermal energy from the at least one fluid in the at least one fluid chamber to the at least one housing body.
